(19) United States
(12) Patent Application Publication
(10) Pub. No.: US 2001/0005451 A1
(43) Pub. Date: Jun. 28, 2001

(54) Image intermittent recording device and its method

(76) Inventor: Eiki Obara, Hiki-gun (JP)

Correspondence Address: Pillsbury Madison Sutro, LLP, Ninth Floor, East Tower, 1100 New York Avenue, N.W., Washington, DC, 20005-3918, US

(21) Appl. No.: 09/748,237

(22) Filed: Dec. 27, 2000

(30) Foreign Application Priority Data
Dec. 27, 1999 (JP) 11-370997

(51) Int. Cl. H04N 7/26; H04N 5/781; H04N 5/85; H04N 5/90; H04N 5/91

(52) U.S. Cl. 386/111; 386/125

(57) ABSTRACT

Digital images to be inputted in frames are specified at specific time intervals. When the specified digital images are subjected to an MPEG coding process and the resulting images are recorded on a recording medium, control is performed in such a manner that, as the time interval of intermittent recording becomes longer, the number of pictures constituting a GOP, a unit of MPEG coding, becomes smaller, thereby increasing the frequency of appearance of I pictures.

### CROSS-REFERENCE TO RELATED APPLICATIONS

This application is based upon and claims the benefit of priority from the prior Japanese Patent Application No. 11-370997, filed Dec. 27, 1999, the entire contents of which are incorporated herein by reference.

### BACKGROUND OF THE INVENTION

This invention relates to an image intermittent recording device which encodes and compresses the digital images obtained by photographing a subject at specific time intervals and records the compressed images, and to its method.

As is generally known, when images are recorded to keep watch with a camera or the like, a recording medium with a large capacity is required to record the images as they are, because the recording is usually done for many hours.

In such watching, there are usually almost no change in the recorded images. Therefore, the images are not necessarily recorded continuously, an intermittent recording method of photographing and recording images at specific time intervals is frequently used to reduce the recording capacity.

On the other hand, with recent advances in digital technology, images have been processed in digital form. At the same time, the technique for compressing digital images by using the correlation between images has progressed. A device using the image compression technique has been finding its way into the application of watching with cameras.

Typical image compression techniques using the correlation between images include JPEG (Joint Photographic Experts Group) used to compress still pictures and MPEG (Moving Picture Image Coding Experts Group) used to compress moving pictures.

When the JPEG compression method is applied to the intermittent recording, the method can compress the data to about one-eighth of its original amount at most because the JPEG method performs only intraframe compression, which leads to the problem of low compression efficiency. Thus, when data is recorded on a recording medium with a specific capacity for a long time by the intermittent method, the recording time intervals are so long that the amount of information runs short.

Furthermore, when the MPEG compression method is applied to the intermittent recording, the method can increase the compression ratio as compared with the case where the JPEG method is used, because the MPEG method makes use of not only intraframe correlation but also interframe correlation. The MPEG method can compress the data to about one-thirtieth to one-fiftieth of its original amount.

When intermittent recording is effected on a recording medium with a specific capacity for a long time, however, the recording time intervals become longer as the time during which the recording is done becomes longer. For this reason, the number of frames constituting a GOP (Group Of Picture), a unit of MPEG coding, is large, which makes the total photographing time longer. This makes the correlation between the photographed frames lower, causing the problem of degrading the picture quality.

Specifically, when recording is done for a long time on a recording medium with a specific capacity, since the compression ratio cannot be increased so much by the JPEG method, the time interval of intermittent recording becomes long. The MPEG method is capable of recording for a longer time than the JPEG method, but recording for a much longer time results in the longer recording time interval, lowering the correlation between images, which causes the problem of degrading the picture quality of reproduced images.

### BRIEF SUMMARY OF THE INVENTION

It is, accordingly, an object of the present invention to overcome the above problems by providing not only an image intermittent recording device which prevents the picture quality of the reproduced images from deteriorating even when intermittent recording is done for a long time on a recording medium with a specific capacity, but also its method.

The foregoing object is accomplished by providing an image intermittent recording device comprising: specifying section for specifying, at specific time intervals, digital images to be inputted in frames; coding section for coding the specific number of frames of digital images specified by the specifying section into coding units composed of a specific number of pictures including intraframe compression coding pictures and interframe compression coding pictures and outputting the resulting pictures; recording section for recording each picture outputted in coding units from the coding section onto a recording medium; and control section for controlling, according to the time interval specified by the specifying section, the number of pictures constituting a coding unit created by the coding section.

The foregoing object is further accomplished by providing an image intermittent recording method comprising: a specifying step of specifying, at specific time intervals, digital images to be inputted in frames; a coding step of coding the specific number of frames of digital images specified in the specifying step into coding units composed of a specific number of pictures including intraframe compression coding pictures and interframe compression coding pictures and outputting the resulting pictures; a recording step of recording each picture outputted in coding units in the coding step onto a recording medium; and a control step of controlling, according to the time interval specified in the specifying step, the number of pictures constituting a coding unit created in the coding step.

With the above configuration and method, digital images to be inputted in frames are specified at the specific time intervals. When the specified number of frames of digital images are coded into coding units composed of a specific number of pictures including intraframe compression coding pictures and interframe compression coding pictures and the resulting pictures are recorded onto a recording medium, the number of pictures constituting the coding unit is controlled in coding according to the specified time interval. This prevents the picture quality of the reproduced images from deteriorating even when intermittent recording is done on a recording medium with a specific capacity for a long time.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a block diagram to help explain an image intermittent recording device and its method according to an embodiment of the present invention;

FIG. 2 illustrate the picture arrangement when the number N of pictures constituting one GOP is set at 15 in effecting 1/10intermittent recording in the embodiment; and

FIG. 3 illustrates the picture arrangement when the number of pictures constituting one GOP is set at 9 in effecting 1/30 intermittent recording in the embodiment.

### DETAILED DESCRIPTION OF THE INVENTION

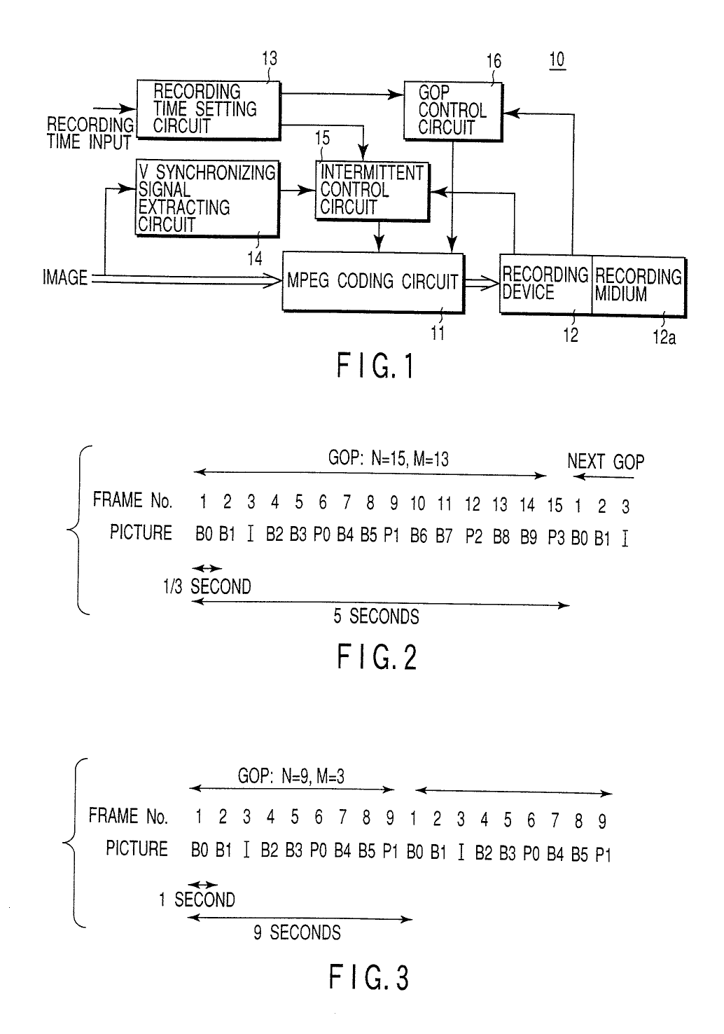

Hereinafter, referring to the accompanying drawings, an embodiment of the present invention will be explained in detail. FIG. 1 shows an image intermittent recording device 10 according to the embodiment. As shown in FIG. 1, the image intermittent recording device 10 comprises an MPEG coding circuit 11 for receiving digital images in frames and coding them according to the MPEG standard, a recording device 12 for recording the compressed image coded by the MPEG coding circuit 11 in a DVD (Digital Versatile Disc) or another type of a specific recording medium 12a that enables recording and reproduction of data, a recording time setting circuit 13 for setting the recording time inputted by the operator, a V synchronizing signal extracting circuit 14 for extracting the V (vertical) synchronizing signal indicating the starting time from the inputted images in frames, an intermittent control circuit 15 under the control of the V synchronizing signal extracting circuit 14 for determining the time interval of intermittent recording according to the recording time received from the recording time setting circuit 13 and the recording capacity of the recording medium 12a received from the recording device 12 and informing the MPEG coding circuit 11 of the determined time interval, and a GOP control circuit 16 for determining not only the number N of pictures constituting a GOP, a unit of coding but also the frequency of appearance of I or P pictures according to the recording time received from the recording time setting circuit 13 and the recording capacity of the recording medium 12a received from the recording device 12 and informing the MPEG coding circuit 11 of the determined number N and the determined frequency M.

The operation of the image intermittent recording device 10 of FIG. 1 will be explained, taking the case of 1/10intermittent recording shown in FIG. 2. First, digital images in consecutive frames are inputted to the MPEG coding circuit 11. These images are selected by the intermittent control circuit 15 that orders MPEG coding according to the V synchronizing signal extracted by the V synchronizing signal extracting circuit 14.

Specifically, the intermittent control circuit 15 determines the recording time interval according to the recording capacity of the recording medium 12a set in the recording device 12 and the recording time set in the recording time setting circuit 13. In this case, the operator inputs the recording time to the recording time setting circuit 13. Alternately, another device (not shown) inputs the recording time automatically to the recording time setting circuit 13.

In the configuration of FIG. 1, it is assumed that the normal recording time of the recording medium 12a set in the recording device 12 is three hours and that the operator has set the recording time of 30 hours in the recording time setting circuit 13.

In this case, 30 hours of recording requires 1/10intermittent recording. Thus, the intermittent control circuit 15 instructs the MPEG coding circuit 11 to perform MPEG coding at a rate of one out of ten frames to do 1/10intermittent recording.

According to the recording time of three hours of the recording medium 129 in the recording device 12 and the recording time of 30 hours set in the recording time setting circuit 13, for example, the GOP control circuit 16 sets the number N of pictures constituting one GOP at 15 and the frequency M at which I or P pictures appear at 3 as shown in FIG. 2. The values of N and M set by the GOP control circuit 16 are supplied to the MPEG coding circuit 11.

Continues recording usually produces the image of each frame every 1/30 second and therefore its 1/10intermittent recording produces the image of each frame every ⅓second. Since the number N of pictures constituting one GOP is 15, MPEG coding is performed in units of 15 frames, frame numbers 1 to 15. One GOP corresponds to 5 seconds.

In FIG. 2, the code written under each frame number indicates each picture obtained relatively later in timing after MPEG coding.

For example, an I picture subjected to intraframe correlation is obtained from the image with frame number 3. Pictures B0, B1 are the B pictures obtained from the last P picture and the I picture with frame number 3 in the preceding GOP, respectively, through bidirectional prediction.

Furthermore, picture P0 at the position of frame number 6 is the P picture obtained from I picture with frame number 3 through forward prediction coding. Pictures B2, B3 are the B pictures obtained from the I picture and P0 picture, respectively, through bidirectional prediction.

In addition, picture P1 with frame number 9 is the P picture obtained from P0 picture with frame number 6 through forward prediction coding. Pictures B4, B5 are the B pictures obtained from P0 picture with frame number 6 and P1 picture with frame number 9, respectively, through bidirectional prediction coding.

Moreover, picture P2 with frame number 12 is the P picture obtained from P1 picture with frame number 9 through forward prediction coding. Pictures B6, B7 are the B pictures obtained from P1 picture with frame number 9 and P2 picture with frame number 12, respectively, through bidirectional prediction coding.

Still furthermore, picture P3 with frame number 15 is the P picture obtained from P2 picture with frame number 12 through forward prediction coding. Pictures B8, B9 are the B pictures obtained from P2 picture with frame number 12 and P3 picture with frame number 15, respectively, through bidirectional prediction coding.

In this way, another I picture is obtained from the position 15 frames beyond the I picture with frame number 3. That is, I pictures are obtained at intervals of 15 frames. Each picture in one GOP obtained through MPEG coding is sent to the recording device 12, which records it onto the recording medium 12a.

Then, it is assumed that the operator has inputted the recording time of 90 hours to the recording time setting circuit 13. Here, if the recording medium 12a set in the recording device 12 has the recording capacity of three hours as described above, 1/30 intermittent recording is needed.

To effect 1/30 intermittent recording, the intermittent control circuit 15 counts the V synchronizing signals extracted by the V synchronizing signal extracting circuit 14 and instructs the MPEG coding circuit 11 to perform MPEG coding at a rate of one out of 30 frames.

At this time, if the GOP control circuit 16 sets the number N of pictures constituting one GOP at 9 and the frequency M of appearance of I or P pictures at 3, MPEG coding is effected using nine images of each frame obtained in one second interval as a unit as shown in FIG. 3.

That is, an I picture is obtained by subjecting the image with frame number 3 to intraframe correlation. Pictures B0, B1 are the B pictures obtained from the last P picture and the I picture with frame number 3 in the preceding GOP, respectively, through bidirectional prediction coding.

Furthermore, picture P0 with frame number 6 is the P picture obtained from I picture with frame number 3 through forward prediction coding. Pictures B2, B3 are the B pictures obtained from the I picture and P0 picture, respectively, through bidirectional prediction coding.

In addition, picture P1 with frame number 9 is the P picture obtained from P0 picture with frame number 6 through forward prediction coding. Pictures B4, B5 are the B pictures obtained from P0 picture with frame number 6 and P1 picture with frame number 9, respectively, through bidirectional prediction coding.

FIG. 3 is the same as FIG. 2 in that an I picture is obtained by subjecting the image with frame number 3 to intraframe compression. FIG. 3, however, differs from FIG. 2 in that the next I picture is obtained from the position nine frames beyond the I picture with frame number 3 and therefore I pictures are obtained at intervals of nine frames.

In the embodiment, when the time interval of intermittent recording lengthens from 1/10to 1/30, the number N of pictures constituting one GOP decreases from 15 to 9. This increases the frequency of appearance of I pictures, which prevents the picture quality of the reproduced images from deteriorating because the recording time interval becomes longer.

The present invention is not limited to the embodiment. For instance, the present invention may be applied to not only the recording device 12 using a removable recording medium but also a built-in recording device. With the present invention, when the recording time interval becomes longer, the number N of pictures constituting one GOP is decreased and the frequency of appearance of I pictures is increased.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image intermittent recording device comprising:
specifying means for specifying, at specific time intervals, digital images to be inputted in frames;
coding means for coding the specific number of frames of digital images specified by the specifying means into coding units composed of a specific number of pictures including intraframe compression coding pictures and interframe compression coding pictures and outputting the resulting pictures;
recording means for recording each picture outputted in coding units from the coding means onto a recording medium; and
control means for controlling, according to the time interval specified by said specifying means, the number of pictures constituting a coding unit created by said coding means.

2. The image intermittent recording device according to claim 1, wherein said control means performs control in such a manner that, as the time interval specified by said specifying means becomes longer, the number of pictures constituting a coding unit created by said coding means becomes smaller.

3. The image intermittent recording device according to claim 1, wherein said control means controls the number of pictures constituting a coding unit created by said coding means, on the basis of the recording time externally inputted and set and the recording capacity of said recording medium.

4. The image intermittent recording device according to claim 1, wherein said specifying means determines said time interval on the basis of the recording time externally inputted and set and the recording capacity of said recording medium.

5. The image intermittent recording device according to claim 1, wherein said specifying means specifies a digital image at said specific time intervals by counting the vertical synchronizing signals of the digital images inputted in frames.

6. The image intermittent recording device according to claim 1, wherein said recording medium is a DVD.

7. An image intermittent recording device comprising:
specifying section for specifying, at specific time intervals, digital images to be inputted in frames;
coding section for coding the specific number of frames of digital images specified by the specifying section into coding units composed of a specific number of pictures including intraframe compression coding pictures and interframe compression coding pictures and outputting the resulting pictures;
recording section for recording each picture outputted in coding units from the coding section onto a recording medium; and
control section for controlling, according to the time interval specified by said specifying section, the number of pictures constituting a coding unit created by said coding section.

8. An image intermittent recording method comprising:
a specifying step of specifying, at specific time intervals, digital images to be inputted in frames;
a coding step of coding the specific number of frames of digital images specified in the specifying step into coding units composed of a specific number of pictures including intraframe compression coding pictures and interframe compression coding pictures and outputting the resulting pictures;
a recording step of recording each picture outputted in coding units in the coding step onto a recording medium; and
a control step of controlling, according to the time interval specified in said specifying step, the number of pictures constituting a coding unit created in said coding step.

9. The image intermittent recording method according to claim 8, wherein said control step performs control in such a manner that, as the time interval specified in said specifying step becomes longer, the number of pictures constituting a coding unit created in said coding step becomes smaller.

10. The image intermittent recording method according to claim 8, wherein said control step controls the number of pictures constituting a coding unit created in said coding step, on the basis of the recording time externally inputted and set and the recording capacity of said recording medium.

11. The image intermittent recording method according to claim 8, wherein said specifying step determines said time interval on the basis of the recording time externally inputted and set and the recording capacity of said recording medium.

12. The image intermittent recording method according to claim 8, wherein said specifying step specifies a digital image at said specific time intervals by counting the vertical synchronizing signals of the digital images inputted in frames.
